(19) United States
(12) Patent Application Publication
(10) Pub. No.: US 2024/0270196 A1
(43) Pub. Date: Aug. 15, 2024

(54) HYBRID SENSING METHOD FOR ACTIVATABLE PROTECTION DEVICES

(71) Applicant: GM GLOBAL TECHNOLOGY OPERATIONS LLC, Detroit, MI (US)

(72) Inventors: Michael G. Carpenter, Romeo, MI (US); Chad T. Zagorski, Clarkston, MI (US); Kathryn E. Koski, New Baltimore, MI (US); Andrew R. Dwoinen, Sterling Heights, MI (US)

(73) Assignee: GM GLOBAL TECHNOLOGY OPERATIONS LLC, Detroit, MI (US)

(21) Appl. No.: 18/188,511

(22) Filed: Mar. 23, 2023

Related U.S. Application Data
(60) Provisional application No. 63/484,600, filed on Feb. 13, 2023.

(51) Int. Cl. B60R 21/34; B60R 21/0134; H04B 17/318

(52) U.S. Cl. CPC B60R 21/34; B60R 21/0134; H04B 17/318; B60R 2021/346

(57) ABSTRACT

A method, system, and host vehicle mitigate an encounter with a vulnerable road user (VRU) by performing pedestrian protection countermeasures when the VRU encounter is detected and an event with the VRU encounter is anticipated. The method includes determining, via a primary detection process using the controller, if the VRU encounter is probable, and determining, via a secondary detection process using the controller, if the VRU encounter has occurred. The method includes performing one or more pedestrian protection countermeasures based on a respective result of the primary and secondary detection processes. The primary detection process may utilize a passive sensing device and the secondary detection process may utilize an ADAS sensor, or vice versa.

### CROSS-REFERENCE TO RELATED APPLICATIONS

This application claims priority to and the benefit of U.S. Provisional Application Ser. No. 63/484,600 filed on Feb. 13, 2023, which is hereby incorporated by reference in its entirety.

### INTRODUCTION

The present disclosure is related to activatable protection devices aboard a host vehicle, e.g., a motor vehicle. More specifically, the present disclosure pertains to systems and methods for activating such protection devices aboard the host vehicle by performing one or more pedestrian protection-countermeasures in response to detection of potential encounters with pedestrians, bicyclists, or other vulnerable road users (VRUs) and/or events during which such encounters are anticipated or likely. As vehicle sensing and computational capabilities evolve, host vehicles increasingly incorporate hardware devices and software-based processes for avoiding and responding to such VRU encounters, as well as encounters with other vehicles. However, protection devices tend to be relatively limited in terms of possible deployment locations on or within the host vehicle. This is largely due to the need to facilitate post-deployment processes and services. Additionally, the current state of the art in this area may limit available styling choices of the host vehicle.

### SUMMARY

The present disclosure provides methods and systems for mitigating effects of encounters with a pedestrian, bicyclists, or another vulnerable road user (VRU). The method, which is performed aboard a host vehicle in accordance with the disclosure, may include determining if a VRU encounter is probable. This action occurs via a primary detection process. The method also includes determining via a secondary detection process if the VRU encounter has in fact occurred, and thereafter performing one or more pedestrian protection countermeasures using an event mitigation device (EMD) of the host vehicle. Use of the EMD occurs based on results of the primary and secondary detection processes in the manner set forth below.

The primary detection process may use a passive sensing device. The secondary detection process in such an embodiment may utilize an Advanced Driver-Assistance System (ADAS) sensor, with the result of the secondary sensing process used to modify a threshold value for activating the above-noted EMD. Alternatively, the primary detection process may utilize the ADAS sensor and the secondary detection process may utilize the passive sensing device, with the result of the primary sensing process optionally used to modify the threshold value for activating the EMD.

A comparison could involve determining (i) that the passive sensing device detected the VRU encounter, and (ii) a strength of a signal related to this determination. If the signal strength is greater than a first threshold, the EMD may be activated. However, the ADAS sensor detects the VRU encounter if the signal strength is not greater than the first threshold. If the ADAS sensor detects the VRU encounter, the first threshold is automatically reduced to a lower second threshold. The EMD is activated if the signal strength exceeds the lower threshold. The method may further include not activating the EMD if the passive sensing device does not detect the aforementioned VRU encounter.

In another embodiment, the primary detection process may utilize the ADAS sensor and the secondary detection process may utilize the passive sensing device. The comparison in such a case may include determining if the ADAS sensor has detected the VRU encounter. If so, the first threshold may be reduced to the lower second threshold. The EMD is activated in this embodiment if the passive sensing device detects the VRU encounter and a strength of a signal related to the detection exceeds the lower second threshold. If the ADAS sensor does not detect the VRU encounter, the EMD may be activated if the passive sensing device detects the VRU encounter and the strength of signal exceeds the first threshold. The method may further include not activating the EMD if the passive sensing device does not detect the VRU encounter or the passive sensing device detects the VRU encounter, and the strength of signal does not exceed the second threshold.

The passive sensing device may be optionally embodied as an accelerometer and/or a pressure tube sensor. The ADAS sensor in turn may include a camera, a radar sensor, and/or a lidar sensor. The method may further include determining if the VRU is present within a predetermined distance of the host vehicle, e.g., according to classification data of the VRU, in which case the decision to activate the EMD could include evaluating the classification data. The classification data may include a distance to the VRU, a rate of movement, threat level, acceleration profile, size, and/or position of the VRU, or a type of vehicle in which the VRU is located, and/or a pressure profile.

The system in accordance with another aspect of the disclosure may include an activatable EMD located at one or more locations of the host vehicle, a passive sensing device, an ADAS sensor, and a processor configured to perform the present method. The host vehicle in this implementation includes a vehicle body, road wheels connected to the vehicle body, the EMD, the passive sensing device, the ADAS sensor, and the processor.

A host vehicle is also disclosed herein for mitigating an encounter with a VRU. The host vehicle in accordance with an aspect of the disclosure includes a vehicle body, road wheels connected to the vehicle body, an EMD connected to the vehicle body, a passive sensing device, an ADAS sensor, and a processor. The processor is configured to execute computer-readable instructions from a computer-readable storage medium to cause the processor to perform the above-summarized methods:

The above summary is not intended to represent every application or every aspect of the present disclosure. Rather, the foregoing summary merely provides an exemplification of some of the novel concepts and features set forth herein. The above features and advantages, and other features and advantages, will be readily apparent from the following detailed description of illustrated applications and representative modes for carrying out the disclosure when taken in connection with the accompanying drawings and appended claims. Moreover, the present disclosure expressly includes any and all combinations and sub-combinations of the elements and features presented previously and subsequently.

### BRIEF DESCRIPTION OF THE DRAWINGS

FIG. 1 illustrates a representative host vehicle configured to perform a method in accordance with the disclosure.

FIG. 2 is a flow chart describing a method for performing vulnerable road user (VRU)-protection countermeasures using a passive sensing device as a primary detection process and an Advanced Driver-Assistance System (ADAS) sensor as a secondary detection process according to an aspect of the present disclosure.

FIG. 3 is a flow chart describing an alternative embodiment of the method of FIG. 2 that uses the ADAS sensor of FIG. 1 as a primary detection process and the passive sensing device of FIG. 1 as a secondary detection process.

The present disclosure may be extended to modifications and alternative forms, with representative applications illustrated in the drawings and disclosed in detail herein. Inventive aspects of the present disclosure are not limited to the disclosed applications. Rather, the present disclosure is intended to cover modifications, equivalents, combinations, and alternatives falling within the scope of the disclosure as defined by the appended claims.

### DETAILED DESCRIPTION

The following description is merely exemplary in nature and is not intended to limit the present disclosure, application, or uses. It should also be understood that throughout the drawings, corresponding reference numerals indicate like or corresponding parts and features. The present disclosure may be applied in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the Claims section, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation.” Moreover, words of approximation such as “about,” “almost,” “substantially,” “generally,” “approximately,” etc., may be used herein in the sense of “at, near, or nearly at,” or “within 0-5% of,” or “within acceptable manufacturing tolerances,” or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

As appreciated in the art, some designs for activatable protective devices with regard to a VRU utilize activatable hood structures and/or external airbags activated by pyrotechnic devices or other suitable means. Such devices typically rely on pressure tube sensors or other event-based sensing approaches to detect the VRU or encounters therewith, an event involving the detected VRU encounter has occurred, and an activatable event mitigation device (EMD) should be activated. Pressure tube sensors in particular have specific position and structural packaging criteria that tend to restrict product styling choices. Such systems also incur additional costs for service after EMD is deployed. Additionally, event-based sensing activates the EMD after a contact event or other encounter with the VRU is detected, and thus may limit the time available for EMD deployment.

The present disclosure addresses these and other potential issues by utilizing alternative processes that integrate ADAS sensors with more traditional passive sensing technologies. This approach may enable replacement of the above-noted pressure tube sensors or expansion of the pressure tube sensor's allowable packaging locations. By utilizing ADAS sensors such as camera modules, radar, or lidar sensors, the present disclosure presents a sensing approach that combines forward-looking capabilities of the various sensors with contact-based sensing to enhance the capabilities of activatable protection devices.

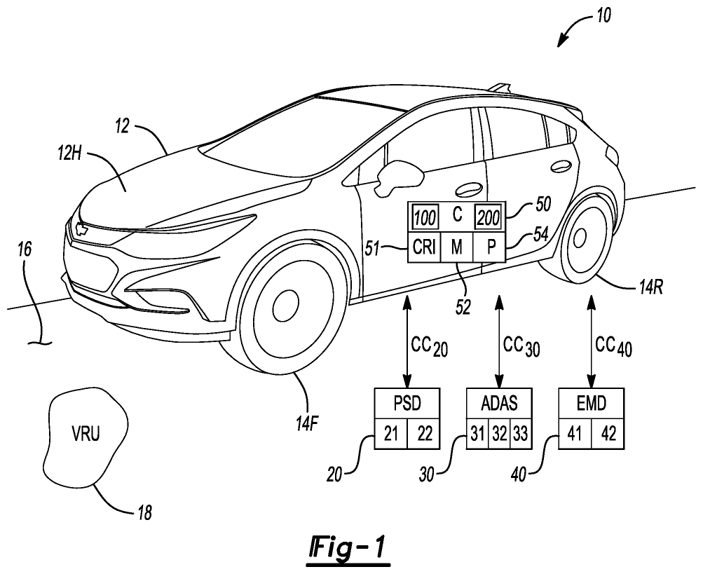

Referring now to FIG. 1, a host vehicle 10 includes an electronic control unit/controller (C) 50 connected to a vehicle body 12. The vehicle body 12 in turn is connected to respective front and rear road wheels 14F and 14R in the illustrated construction. Although depicted in FIG. 1 as a representative passenger motor vehicle, the host vehicle 10 could be variously embodied as a truck, farm equipment, or other mobile platform operable for traveling along a road surface 16.

During such travel, the host vehicle 10 could potentially encounter a vulnerable road user (VRU) 18 in its path or proximity. As contemplated herein, the VRU 18 may include individual persons such as pedestrians, bicyclists, road workers, animals, or occupants of other vehicles (not shown). Such individuals are generally more vulnerable to forces than are solid structures such as the host vehicle 10. Thus, the host vehicle 10 is equipped with one or more EMDs 40 as set forth below, which automatically deploy during an encounter with the VRU 18.

As appreciated in the art, deployable VRU protection devices typically rely on contact-based sensing, automatic emergency braking, and forward-looking sensors such as cameras and radar to accurately perceive the surrounding environment. In contrast, the host vehicle 10 of FIG. 1 is equipped with a “hybrid” sensing approach that combines such forward-looking capabilities with contact-based sensing to enhance VRU protection capabilities, while at the same time minimizing or eliminating placement limitations as noted above, in particular of current pressure tube sensors.

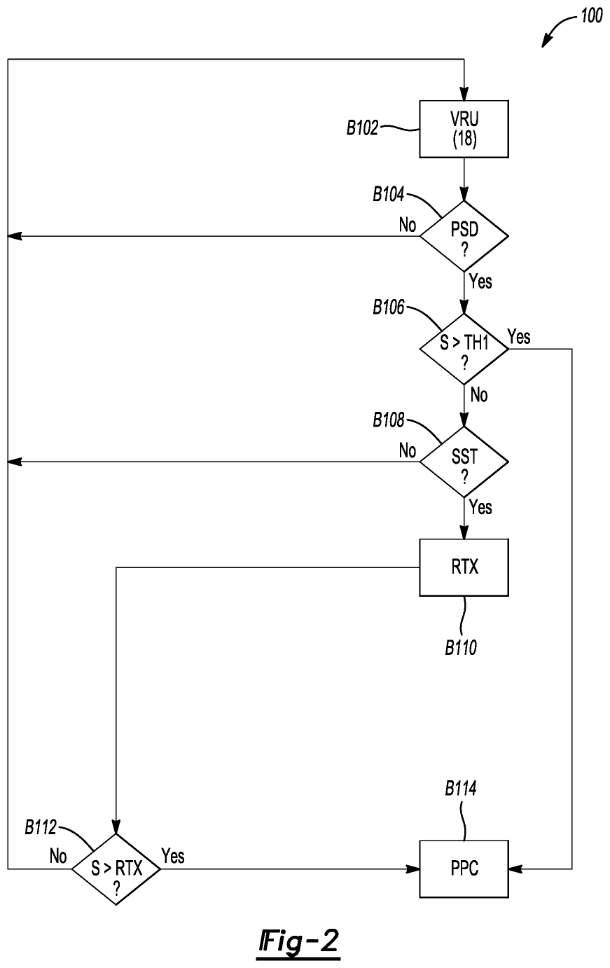

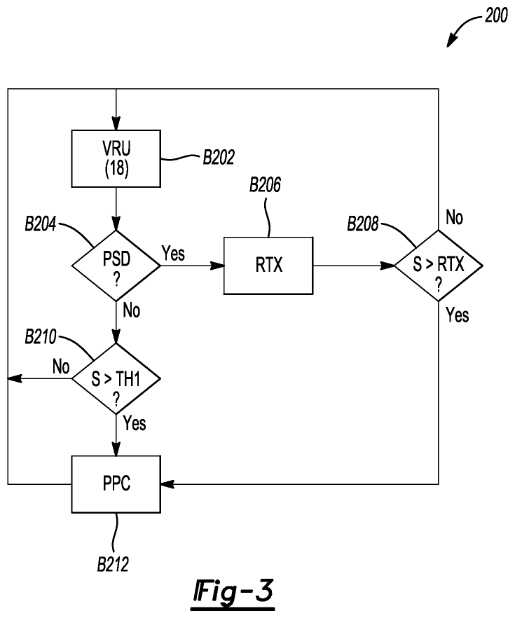

The host vehicle 10 is equipped with the controller 50, which in turn is configured in one or more embodiments to perform the method 100 of FIG. 2 and an alternative method 200 of FIG. 3. To that end, the controller 50 includes computer-readable instructions (CRI) 51 recorded in a non-transitory computer-readable storage medium/memory (M) 52. The CRI 51 are executed by one or more processors (P) 54. The memory 52 may include tangible, non-transitory memory, e.g., read only memory, e.g., optical, magnetic, flash, or another suitable type. The controller 50 may also include application-sufficient amounts of random-access memory, electrically-erasable programmable read only memory, and similar memory, as well as a high-speed clock, analog-to-digital and digital-to-analog circuitry, and input/output circuitry and devices, as well as appropriate signal conditioning and buffer circuitry.

The processor 54 in turn may be constructed from various combinations of Application Specific Integrated Circuit(s) (ASICs), Field-Programmable Gate Arrays (FPGAs), electronic circuits, central processing units, e.g., microprocessors, and the like. Non-transitory components of the memory 52 are capable of storing machine-readable instructions in the form of one or more software or firmware programs or routines, combinational logic circuit(s), input/output circuit(s) and devices, signal conditioning and buffer circuitry and other components that can be accessed by one or more processors 54 to provide a described high-voltage discharge functionality.

Input/output circuits and devices for use with the controller 50 of FIG. 1 may include analog/digital converters and related devices that monitor inputs from sensors, with such inputs monitored at a preset sampling frequency or in response to a triggering event. Software, firmware, programs, instructions, control routines, code, algorithms, and similar terms mean controller-executable instruction sets including calibrations and look-up tables.

In order to perform the methods 100 and 200 as described in detail below, the host vehicle 10 of FIG. 1 is also equipped with one or more passive sensing devices (PSD) 20 and one or more Advanced Driver Assistance System (ADAS) sensors 30, both of which are described in singular terms below for simplicity. The passive sensing device 20 may include an accelerometer 21 and/or a pressure tube sensor 22 in possible constructions. As understood in the art, the pressure tube sensor 22 is operable for measuring fluidic or gaseous pressure inside of a defined volume of a tube, with the tube portion of the tube sensor 22 being constructed of a pressure-sensitive metal or polymer material. The pressure tube sensor 22 is configured to measure deflection or strain caused by pressure changes, with typical pressure tube sensors being sensitive to very small pressure fluctuations. The ADAS sensor 30 for its part may include one or more cameras 31, e.g., visible spectrum, infrared, etc., a radar sensor 32, a lidar sensor 33, and the like.

The EMD 40 may be located at various locations of the host vehicle 10. For example, the EMD 40 may include deployable hood structures 41 or airbags 42 in a possible implementation, with at least some of the airbags 42 being configured to deploy external to the host vehicle 10 to protect the VRU 18. For example, the deployable hood structures 41 or airbags 42 could deploy from or around a vehicle hood 12H. The controller 50 is thus programmed to communicate with the PSD(s) 20, the ADAS sensor(s) 30, and the EMD(s) 40 via electronic control signals CC₂₀, CC₃₀, and CC₄₀, respectively, in the course of performing the methods 100 and 200.

When the host vehicle 10 is equipped as shown in FIG. 1, it is possible to increase vehicle styling or design options typically limited by the use of the above-noted pressure tube sensors 22. The present disclosure may also provide earlier information to the controller 50 when detecting the encounter with the VRU 18, as well as more specific characterization details related to an identified VRU 18 or encounter therewith. Doing so provides opportunities to further optimize timing and deployment characteristics associated with the EMD(s) 40. By combining pre-event sensing with event sensing for earlier detection and classification of an identified VRU 18, slower-activating resettable EMDs 40 and other devices could be enabled at a reduced cost and repair requirement level compared to, e.g., pyrotechnic devices.

Referring now to FIG. 2, the method 100 enables the performance of protection countermeasures for encounters with the VRU 18 of FIG. 1, with such encounters being actual or potential contact between the host vehicle 10 and the VRU 18. This occurs in the non-limiting implementation of FIG. 1 using the passive sensing device(s) 20 of FIG. 1 in a primary detection process and the Advanced Driver Assistance System (ADAS) sensor(s) 30 in a secondary detection process. As illustrated in FIG. 2, the method 100 is based on using the passive sensing device 20 as a nominal “primary sensor” during the above-noted primary detection process, with the ADAS sensor 30 of FIG. 1 utilized as a nominal “secondary sensor” for the secondary detection process. More than one of the passive sensing devices 20 may be utilized by the primary detection process and more than one ADAS sensor 30 may be utilized by the secondary detection process.

The method 100 is shown in FIG. 2 in simplified form as being organized into discrete logic blocks. Each logic block in turn represents a particular step, function, or subprocess that is to be performed via the controller 50 of FIG. 1 when executing the present method 100. The method 100 of FIG. 1 begins at block B102 (“VRU (18)”) with a primary sensor monitoring for an encounter of the host vehicle 10 and the VRU 18. Block B102 in this particular embodiment includes using the passive sensing device 20 to detect the presence of the VRU 18, and thus entails processing readings from the accelerometer 21 and/or the pressure tube sensor 22 of FIG. 1. The method 100 proceeds to block B104 once the controller 50 has begun to receive information from the passive sensing device 20.

In block B104 (“PSD?”), the controller 50 of FIG. 1 next determines if the primary sensor of block B102 has detected an encounter with the VRU 18 shown in FIG. 1. If it is determined in block B104 that the primary sensor, in this case the passive sensing device 20, did not detect such an encounter, the method 100 returns to block B102 where monitoring continues. If it is instead determined in block B104 that the passive sensing device 20 has detected the aforementioned encounter, the method 100 proceeds in the alternative to block B106.

In block B106 of FIG. 2 (“S>TH1?”), the controller 50 of FIG. 1 next determines if a strength of a signal (“S”) related to the detected encounter as detected by the primary sensor/passive sensing device 20 in block B102 is greater than a predetermined first threshold (TH1). The method 100 proceeds to block B114 if the signal strength is greater than the first threshold. The method 100 proceeds in the alternative to block B108 when the signal strength is not greater than the first threshold.

In block B108 of FIG. 2 (“SST?”), it is next determined if the secondary sensor, in this exemplary case the ADAS sensor 30 shown in FIG. 1, has tracked or detected the encounter with the VRU 18 of FIG. 1. If the secondary sensor/ADAS sensor 30 has not detected the encounter, e.g., an output signal from the ADAS sensor 30 does not correspond to such a detection result, the method 100 returns to block B102 where monitoring continues. If however it is determined in block B108 that the secondary sensor has tracked or detected the encounter with the VRU 18, the method 100 instead proceeds to block B110.

At block B110 (“RTX”), the threshold (TH1) is reduced by a calibrated or predetermined percentage (X %). The percentage may be incremental or larger in different implementations. The method 100 then proceeds to block B112.

At block B112 (“S>RTX?”), the controller 50 of FIG. 1 next determines if the signal strength (S) from the designated primary sensor is greater than the reduced threshold (RTX). Multiple thresholds could be used in one or more alternative implementations if more than one ADAS sensor 30 is used for tracking the VRU 18 of FIG. 1, where such reduction thresholds could have different corresponding values. If the controller 50 determines in block B112 that the signal strength related to the encounter detected by the primary sensor/passive sensing device 20 of FIG. 1 is not greater than the reduced threshold (RTX), the method 100 returns to block B102 where monitoring continues. If it is instead determined in block B112 that the signal strength related to the encounter detected by the primary sensor is greater than the reduced threshold, the method 100 instead proceeds to block B114.

Block B114 (“PPC”) includes performing one or more pedestrian protection countermeasures, e.g., by commanding deployment of the EMD(s) 40 of FIG. 1. In a first representative application of method 100, the accelerometer 21 of FIG. 1 could provide primary detection of a potential encounter involving an identified VRU 18 as classification data of the VRU 18. The ADAS sensor 30 of FIG. 1 in turn may provide secondary detection that an event with the identified VRU 18 was detected in order to activate pedestrian protection countermeasures, or to verify that the controller 50 should not command the pedestrian protection countermeasures if imminent contact or another encounter of the host vehicle 10 with the VRU 18 is not detected.

A second application of the method 100 is similar to the first. In the second representative application, the pressure tube sensor 22 of FIG. 1 is utilized to provide primary detection of a potential encounter involving an identified VRU 18 and classification data of the VRU 18. The ADAS sensor 30 provides secondary detection that an encounter with the identified VRU 18 was detected in order to activate pedestrian protection countermeasures and to not activate the pedestrian protection countermeasures if an imminent contact with the VRU 18 was not detected. The process of the second application is similar to the process of the first application in that the pedestrian protection countermeasures is selectively activated based upon a predetermined pressure threshold. The second application facilitates packaging of the pressure tube sensor(s) 22 of FIG. 1 at alternate heights and/or positions of the host vehicle 10 in which the activatable EMD 40 is located, thereby reducing styling restrictions.

Referring now to FIG. 3, the method 200 depicts an alternative implementation of the method 100 of FIG. 2 in which pedestrian protection countermeasures are determined using the ADAS sensor(S) 30 in a primary detection process, and using the passive sensing device(s) 20 in a secondary detection process. The method 200 is otherwise analogous to the method 100 described above.

The method 200 begins at block B202 (“VRU (18)”) with the designated primary and secondary sensors monitoring for an encounter between the host vehicle 10 of FIG. 1 and the VRU 18. Block B202 is thus analogous to block B102 of the method 100 as shown in FIG. 2. The method 100 proceeds to block B204.

In block B204 (“PSD?”) the controller 50 determines if the primary sensor alone, i.e., the ADAS sensor 30, has detected an impending event with the VRU 18. If so, the method 200 proceeds to block B206 (“RTX”) where a first threshold is reduced by a predetermined percentage to a reduced threshold (RTX) before proceeding to block B208. If instead the controller 50 determines in block B204 that the primary sensor of method 200 did not detect an impending encounter with the VRU 18, the method 200 proceeds in the alternative to block B210.

At block B208 (“S>RTX?”), the controller 50 next determines if the secondary sensor, i.e., the passive protection device 20, has detected an encounter with the VRU 18 of FIG. 1 and a strength of a signal related to the VRU 18 as detected by the secondary sensor is greater than the reduced threshold. If the controller 50 determines in block B208 that the strength of signal (S) is greater than the reduced threshold (RTX), then the method 200 proceeds to block B212.

Block B210 (“S>TH1?”) includes determining via the controller 50 if the secondary sensor of method 200, i.e., the passive detection device 20, has detected an encounter with the VRU 18 of FIG. 1 and the strength of signal (S) related to the detected encounter exceeds a non-reduced first threshold (TH1). If the secondary sensor in this case has detected an encounter with the VRU 18 and the strength of signal related to the detected encounter exceeds the non-reduced first threshold (TH1), the method 200 proceeds to block B212. If it is instead determined in block B210 that either the secondary sensor did not detect an event with the VRU 18 or the signal strength related to the detected encounter is not greater than the non-reduced first threshold (TH1), the method 200 returns to block B202 where monitoring continues as specified above.

At block B212 (“PPC”), the controller 50 commands performance of the pedestrian protection countermeasures noted above. If it is determined in block B208 that the secondary sensor did not detect an encounter with the VRU 18 or that the signal strength (S) related to the detected encounter is not greater than the reduced threshold (RTX) of block B206, the method 200 returns to block S202 where monitoring continues.

A plurality of ADAS sensors 30 may be located in different areas of the host vehicle 10 in one or more embodiments to observe different areas of the particular field of view being monitored, or different technologies could be utilized to perform the primary determination. Furthermore, a plurality of threshold reductions, which may be different as noted above, may be utilized to reduce the threshold of the signal for performing pedestrian protection countermeasures.

In a first representative application of the present disclosure related to the method 200 of FIG. 3, at least one designated “pre-event” sensor could provide primary detection of a potential event involving an identified VRU 18 of FIG. 1 or encounter therewith as well as classification data of the VRU 18. The accelerometer 21 of FIG. 1 for instance could be used to confirm or provide a secondary detection that an event or encounter with the identified VRU 18 has in fact occurred so as to perform the pedestrian protection countermeasures, and to not perform such countermeasures if contact with the VRU 18 is not predicted or identified. The pre-event sensor in such an embodiment provides detection and classification data related to the VRU 18 to that the controller 50 to perform the above-described process.

The classification data in one or more embodiments may include a distance to the identified VRU 18, a rate of movement of the identified VRU 18, a threat level of a potential event with the identified VRU 18, an acceleration profile of the identified VRU 18, a size of the identified VRU 18, a position of the identified VRU 18, and/or a type of vehicle on or within which the identified VRU 18 is located.

Within the scope of the present disclosure, the controller 50 may be programmed with code that, when executed by the processor 54 of FIG. 1, evaluates acceleration signal strengths from the accelerometer 21 according to various thresholds. This action may occur depending on the range to the VRU 18 as well as a closing rate based upon the identified VRU 18. Such code could activate the pedestrian protection countermeasures upon occurrence of the event based on a predetermined accelerometer threshold, thereby eliminating the need for the pressure tube sensor 22 of FIG. 1.

In a second representative application of the present disclosure related to FIG. 3, at least one pre-event sensor could be utilized to provide primary detection of a potential encounter involving an identified VRU 18 as well as classification data of the VRU 18. The pressure tube sensor 22 is utilized to provide secondary detection that an encounter with the determined VRU 18 has occurred to perform the pedestrian protection countermeasures, and potentially not perform such countermeasures if imminent encounter with the VRU 18 is not detected by the pre-event sensors. The process of the second application is similar to the process of the first application of method 200 in that performance of the countermeasures is based upon VRU data and classification information being provided by the pre-event sensors, and confirmation that an encounter with the VRU 18 has occurred by a predetermined pressure threshold being exceeded, thus causing the EMD(s) 40 of FIG. 1 to deploy. The second application facilitates packaging of the pressure tube sensor 22 at alternate heights and/or locations of the host vehicle 10 in which the EMD 40 is located, thereby reducing styling restrictions.

It is noted that the phrases “strength of a signal” and “signal strength” as used herein with regard to the exemplary embodiments of the methods 100 and 200 as illustrated in FIGS. 2 and 3 do not necessarily represent an electronic signal level, but rather could represent an indication of a “strength” or confidence level of a determination of the imminence of an encounter. In other words, although the term “signal” may represent an actual level of an electronic signal, e.g., a voltage or current, the term “signal” could also represent a broader determination that may include the previously disclosed “classification data”, as will be appreciated by those skilled in the art

The detailed disclosure and the drawings are supportive and descriptive of the present disclosure, but the scope of the present disclosure is defined solely by the appended claims. While some of the best modes and other embodiments for carrying out the present disclosure have been disclosed in detail, various alternative designs and embodiments exist for practicing the present disclosure as recited in the appended claims. Moreover, the present disclosure expressly includes combinations and sub-combinations of the elements and features disclosed herein.

Aspects of the present disclosure have been presented in general terms and in detail with reference to the illustrated embodiments. Various modifications may be made by those skilled in the art without departing from the scope and spirit of the disclosed embodiments. One skilled in the relevant art will also recognize that the disclosed methods and supporting hardware implementations may be alternatively embodied in other specific forms without departing from the scope of the present disclosure. Therefore, the present disclosure is intended to be illustrative without limiting the inventive scope defined solely by the appended claims.

What is claimed is:

1. A method for use aboard a host vehicle having a controller operable for mitigating a vulnerable road user (VRU) encounter, the host vehicle including an event mitigation device (EMD), a passive sensing device, and an Advanced Driver Assistance System (ADAS) sensor, the method comprising:
determining, via a primary detection process using the controller, if the VRU encounter is probable;
determining, via a secondary detection process using the controller, if the VRU encounter has occurred; and
performing one or more pedestrian protection countermeasures via the EMD based on a respective result of the primary detection process and the secondary detection process, wherein:
(i) the primary detection process utilizes the passive sensing device and the secondary detection process utilizes the ADAS sensor, with the result of the secondary sensing process being utilized to modify a threshold for activating the EMD, or (ii) the primary detection process utilizes the ADAS sensor and the secondary detection process utilizes the passive sensing device, with the result of the primary sensing process used to modify the threshold for activating the EMD.

2. The method of claim 1, wherein the primary detection process utilizes the passive sensing device and the secondary detection process utilizes the ADAS sensor, the method further comprising:
determining, via the controller as an encounter event, if the passive sensing device has detected the VRU encounter;
determining a strength of a signal related to the VRU encounter;
if the strength of the signal is greater than a first threshold, activating the EMD via the controller; and
if the strength of the signal is not greater than the first threshold, determining via the controller that the ADAS sensor has detected the VRU and thereafter (i) reducing the first threshold to a lower second threshold, and (ii) activating the EMD when the strength of the signal exceeds the lower threshold.

3. The method of claim 2, further comprising not activating the EMD when the passive sensing device does not detect the VRU encounter.

4. The method of claim 1, wherein the primary detection process utilizes the ADAS sensor and the secondary detection process utilizes the passive sensing device, the method further comprising:
determining if the ADAS sensor has detected the VRU encounter;
if the ADAS sensor has detected the VRU encounter, reducing a first threshold to a lower second threshold and also activating the EMD if (i) the passive sensing device detects the VRU encounter and (ii) a strength of a signal related to detection of the VRU encounter exceeds the lower second threshold; and
if the ADAS sensor does not detect the VRU encounter, activating the EMD if the passive sensing device detects the VRU encounter and the strength of the signal related to the detection of the VRU encounter exceeds the first threshold.

5. The method of claim 4, further comprising:
not activating the EMD if (i) the passive sensing device does not detect the VRU encounter or (ii) the passive sensing device detects the VRU encounter and the strength of the signal does not exceed the lower second threshold.

6. The method of claim 1, wherein:
the passive sensing device includes an accelerometer and/or a pressure tube sensor; and
the ADAS sensor includes one or more of a camera, a radar sensor, or a lidar sensor.

7. The method of claim 1, further comprising:
determining if the VRU is present within a predetermined distance of the host vehicle according to classification data of the VRU; and
activating the EMD comprises evaluating the classification data.

8. The method of claim 7, wherein the classification data comprises a distance to the VRU, a rate of movement of the VRU, a threat level of the VRU, an acceleration profile of the VRU, a size of the VRU, a position of the VRU, a type of vehicle in which the VRU is located, and/or a pressure profile.

9. A system for use aboard a host vehicle for mitigating a vulnerable road user (VRU) encounter with a VRU, comprising:
an activatable event mitigation device (EMD) located on or aboard the host vehicle;
a passive sensing device;
an Advanced Driver-Assistance System (ADAS) sensor; and
a processor, wherein the processor executes computer-readable instructions from a computer-readable storage medium to thereby:
determine if the VRU encounter is probable via a primary detection process;
determine if the VRU encounter has occurred via a secondary detection process; and
perform pedestrian protection countermeasures by activating the EMD based on a respective result of the primary detection process and the secondary detection process, wherein:
either (i) the primary detection process utilizes the passive sensing device and the secondary detection process utilizes the ADAS sensor, with the result of the secondary sensing process utilized to lower a threshold for causing the EMD to activate, or the primary detection process utilizes the ADAS sensor and the secondary detection process utilizes the passive sensing device, with the result of the primary sensing process utilized to modify the threshold for causing the EMD to activate.

10. The system of claim 9, wherein the primary detection process utilizes the passive sensing device and the secondary detection process utilizes the ADAS sensor, and the processor is configured to:
determine that the passive sensing device detects the VRU encounter and a strength of a signal related thereto;
cause the EMD to activate if the strength of the signal is greater than a first threshold; and
if the strength of the signal is not greater than the first threshold, determine that the ADAS sensor detects the VRU, reduce the first threshold to a lower second threshold, and cause the EMD to activate if the strength of the signal exceeds the lower second threshold.

11. The system of claim 10, wherein the processor is configured not to cause the EMD to activate if the passive sensing device does not detect the VRU encounter.

12. The system of claim 9, wherein the primary detection process utilizes the ADAS sensor and the secondary detection process utilizes the passive sensing device, and the processor is configured to:
determine if the ADAS sensor has detected the VRU encounter;
if the ADAS sensor has detected the VRU encounter, reduce a first threshold to a lower second threshold and causes the EMD to activate if the passive sensing device detects the VRU encounter and a strength of a signal related to detection of the VRU encounter exceeds the lower second threshold; and
if the ADAS sensing device does not detect the VRU encounter, cause the EMD to activate if the passive sensing device detects the VRU encounter and a strength of the signal related to detection of the VRU encounter exceeds the first threshold.

13. The system of claim 12, wherein the processor is configured not to cause the EMD to activate if the passive sensing device does not detect the VRU encounter, or the passive sensing device detects the VRU encounter and a strength of the signal does not exceed the lower second threshold.

14. The system of claim 9, wherein:
the passive sensing device includes an accelerometer; and
the ADAS sensor includes one or more of a camera, a radar sensor, or a lidar sensor.

15. The system of claim 9, wherein:
the processor is configured to determine if the VRU is present within a predetermined distance of the host vehicle according to classification data of the VRU; and
causing the EMD to activate comprises evaluating the classification data.

16. The system of claim 15, wherein the classification data comprises a distance to the VRU, a rate of movement of the VRU, a threat level of the VRU, an acceleration profile of the VRU, a size of the VRU, a position of the VRU, a type of vehicle in which the VRU is located, and/or a pressure profile.

17. The system of claim 15, wherein:
the passive sensing device includes a pressure tube sensor; and
the ADAS sensor includes one or more of a camera, a radar sensor, or a lidar sensor.

18. A host vehicle for mitigating a vulnerable road user (VRU) encounter with a VRU, the host vehicle comprising:
a vehicle body;
road wheels connected to the vehicle body;
an event mitigation device (EMD) connected to the host vehicle;
a passive sensing device;
an Advanced Driver-Assistance System (ADAS) sensor; and
a processor, wherein the processor is configured to execute computer-readable instructions from a computer-readable storage medium to cause the processor to:
determine, via a primary detection process, if the VRU encounter is probable;
determine, via a secondary detection process, if the VRU encounter has occurred; and
perform pedestrian protection countermeasures by activating the EMD based on a result of the primary detection process and a result of the secondary detection process, wherein:
either (i) the primary detection process utilizes the passive sensing device and the secondary detection process utilizes the ADAS sensor, with the result of the secondary sensing process used to lower a threshold for activating the EMD, or (ii) the primary detection process utilizes the ADAS sensor and the secondary detection process utilizes the passive sensing device, with the result of the primary sensing process utilized to modify the threshold for activating the EMD.

19. The host vehicle of claim 18, wherein the primary detection process utilizes the passive sensing device and the secondary detection process utilizes the ADAS sensor, and the processor is configured to:
determine that the passive sensing device detects the VRU encounter and a strength of a signal related thereto;
cause the EMD to activate if the strength of the signal is greater than a first threshold; and
if the strength of the signal is not greater than the first threshold, determine that the ADAS sensor detects the VRU encounter, reduce the first threshold to a lower second threshold, and cause the EMD to activate if the strength of the signal exceeds the lower second threshold.

20. The host vehicle of claim 18, wherein the primary detection process utilizes the ADAS sensor and the secondary detection process utilizes the passive sensing device, and wherein the processor is configured to:
determine if the ADAS sensor has detected the VRU encounter;
when the ADAS sensor has detected the VRU encounter, reduce a first threshold to a lower second threshold and cause the EMD to activate if the passive sensing device detects the VRU encounter and a strength of a signal related to the detection exceeds the lower second threshold; and
if the ADAS sensor does not detect the VRU encounter, cause the EMD to activate if the passive sensing device detects the VRU encounter and the strength of the signal exceeds the first threshold.
